(19) United States
(12) Patent Application Publication
(10) Pub. No.: US 2008/0063941 A1
(43) Pub. Date: Mar. 13, 2008

(54) Positive electrode material for nonaqueous electrolyte secondary battery and nonaqueous electrolyte secondary battery

(76) Inventors: Masaharu Itaya, Nishinomiya-city (JP); Shingo Tode, Osaka (JP); Takanobu Chiga, Osaka (JP); Hiroshi Nakamura, Osaka (JP)

Correspondence Address: KUBOVCIK & KUBOVCIK, SUITE 710, 900 17TH STREET NW, WASHINGTON, DC, 20006, US

(21) Appl. No.: 11/898,501

(22) Filed: Sep. 12, 2007

(30) Foreign Application Priority Data
Sep. 13, 2006 (JP) 247872/2006

(51) Int. Cl. H01M 10/24

(52) U.S. Cl. 429/231.95

(57) ABSTRACT

A positive electrode material for a nonaqueous electrolyte secondary battery is obtained which attains good thermal stability and high discharge capacity and shows satisfactory charge-discharge cycle performance characteristics. A nonaqueous electrolyte secondary battery using the positive electrode material is also obtained. Characteristically, the positive electrode material for a nonaqueous electrolyte secondary battery contains a positive active material (e.g., lithium-containing layered complex oxide) capable of lithium storage and release, a lithium phosphate compound such as Li₃PO₄, and Al₂O₃. The lithium phosphate compound and Al₂O₃ are preferably disposed near the positive active material.

### BACKGROUND OF THE INVENTION

1. Technical Field

The present invention relates to a positive electrode material for a nonaqueous electrolyte secondary battery, a nonaqueous electrolyte secondary battery using the positive electrode material, and a method for production of a positive electrode material for a nonaqueous electrolyte secondary battery.

2. Background Art

With the rapid progress of reduction in size and weight of mobile information terminals, such as mobile telephones, notebook personal computers and PDA, a high-energy-density nonaqueous electrolyte battery has been widely used as a driving power source for those terminals, which uses metallic lithium, an alloy capable of storing and releasing lithium or a carbon material as its negative active material and a lithium transition metal complex oxide represented by the chemical formula: LiMO₂ (M indicates a transition metal) as its positive active material. In recent years, a further increase in capacity and energy density of such a nonaqueous electrolyte battery has been demanded.

A representing example of the aforesaid lithium transition metal complex oxide is a lithium cobalt complex oxide (LiCoO₂). For a nonaqueous electrolyte secondary battery using a lithium transition metal oxide, such as lithium cobaltate, as its positive active material and a carbon material or the like as its negative active material, an end-of-charge voltage is generally set at 4.1-4.2 V. In this case, the active material of the positive electrode utilizes only 50-60% of its theoretical capacity. Therefore, if the end-of-charge voltage is increased to a higher level, a capacity (utilization factor) of the positive electrode can be improved to thereby increase the capacity and energy density of the battery.

However, the higher end-of-charge voltage is considered to render LiCoO₂ more prone to experience structural degradation and increase a tendency of an electrolyte solution to decompose on a surface of the positive electrode, while details thereof are not clear. Accordingly, the battery deterioration during charge-discharge cycles becomes more significant in this case than in the conventional case where the end-of-charge voltage is set at 4.1-4.2 V, which has been a problem. Also, a need of an extended service life remains unsatisfied even in the conventional case where the end-of-charge voltage is set at 4.1-4.2 V.

In order to solve this problem, a method has been proposed which increases the end-of-charge voltage of the battery by mixing (NH₄)₂HPO₄ and Al (NO₃)₃.9H₂O in water to produce AlPO₄ and dipping a lithium cobalt complex oxide in a coating solution containing AlPO₄ to coat the lithium cobalt complex oxide with AlPO₄ (Japanese Patent Laid-Open No. 2003-7299).

In the case where AlPO₄, low in Li-ion conductivity, is disposed near the positive active material, as described above, if discharging is performed, for example, until a discharge potential of the positive electrode reaches 2.75 V (vs. Li/Li⁺), a resistance between the positive active material and the electrolyte solution increases to lower a voltage. As a result, the positive electrode potential reaches 2.75 V (vs. Li/Li⁺) sooner, resulting in the reduced discharge capacity. This is not desirable.

Preparation of a Positive Electrode Material by Mixing an Li-ion conducting LiₓPO_{y} (1≦x≦4, 1≦y≦4) in a positive active material is proposed (Japanese Patent Laid-Open Nos. Hei 10-154532, Hei 11-273674, 2000-11996 and 2000-106210, Japanese Patent Kohyo No. 2002-527873, Japanese Patent Laid-Open No. 2003-308842, and Journal of Power Sources, Vol. 119-121, 1 June 2003, pp. 295-299). However, none of these methods has been sufficient to suppress deterioration of thermal stability, discharge capacity and charge-discharge cycle performance capability.

In Solid State Ionics, Vol. 70-71, Part 1, May-June 1994, pp. 96-100, it is disclosed that a high Li-ion conductivity is attained when Li₃PO₄ and Al₂O₃ exist together.

### SUMMARY OF THE INVENTION

It is an object of the present invention to provide a positive electrode material for a nonaqueous electrolyte secondary battery, which attains good thermal stability and high discharge capacity and exhibits satisfactory charge-discharge cycle performance characteristics, and also provide a nonaqueous electrolyte secondary battery using the positive electrode material and a method for production of the positive electrode material.

The positive electrode material of the present invention for a nonaqueous electrolyte secondary battery is characterized as containing a positive active material capable of storing and releasing lithium, a lithium phosphate compound and Al₂O₃.

Mixing the lithium phosphate compound and Al₂O₃ in the positive active material, in accordance with the present invention, not only improves Li-ion conductivity but also results in obtaining improved thermal stability, high discharge capacity and satisfactory charge-discharge cycle performance characteristics. While the details are not clear, this is presumably because the lithium phosphate compound and Al₂O₃, when disposed near the positive active material, changes an oxidation state of a transition metal present in the positive active material to suppress decomposition of the electrolyte solution, dissolution of the transition metal or destruction of a crystal structure of the positive active material. Also, the lithium phosphate compound—Al₂O₃, because of high Li-ion conductivity, suppresses decline of an initial discharge capacity.

Also, improved thermal stability and charge-discharge cycle characteristics can be obtained even when the positive electrode material of the present invention is used and the end-of-charge voltage is increased to 4.3 V or above. While the details thereof are not clear, this is presumably because the presence of the thermally and chemically stable lithium phosphate compound and Al₂O₃ near the positive active material prevents build-up and concentration of heat in the positive active material.

The lithium phosphate compound in the present invention may be a compound such as represented by LiₓPO_{y} (1≦x≦4, 1≦y≦4). Specific examples of such lithium phosphate compounds include Li₃PO₄, LiPO₃, Li₄P₂O₇, LiP and Li₃P. Among them, Li₃PO₄ is particularly preferred.

A portion of oxygen in the lithium phosphate compound may be replaced by nitrogen. Also, other than the aforesaid lithium phosphate compound, the positive electrode material may further contain another type of phosphate compound.

The lithium phosphate compound and Al₂O₃ in the present invention are preferably obtained by substituting AlPO₄ with Li.

In the present invention, the ratio by weight of the lithium phosphate compound to Al₂O₃ is preferably in the range of 1:10-10:1, more preferably in the range of 1:5-5:1. Good thermal stability as well as satisfactory charge-discharge performance characteristics can be obtained more effectively if the weight ratio is kept within the specified range.

The positive active material in the present invention may be a complex oxide comprised mainly of lithium and a transition metal, for example. More specifically, it may be a lithium-containing layered complex oxide. For example, it may be a lithium-containing complex oxide containing at least cobalt. The lithium-containing complex oxide containing at least cobalt may further contain an element such as Zr or Mg. Also, the lithium-containing complex oxide may further contain another element such as nickel or manganese. In case of containing nickel, it may be a lithium nickel cobalt complex oxide, for example.

In the present invention, preferably, the total amount of the lithium phosphate compound and Al₂O₃ does not exceed 10% by weight, based on the weight of the positive active material. If it exceeds 10% by weight, the lithium phosphate compound and Al₂O₃, which play no part in a charge-discharge reaction, increase the irrelative amount, possibly resulting in the failure to obtain a sufficiently high battery capacity. The total amount of the lithium phosphate compound and Al₂O₃ is preferably at least 0.1% by weight, based on the weight of the positive active material.

The method of the present invention for production of a positive electrode material for a nonaqueous electrolyte secondary battery can be employed to produce the positive active material of the present invention. The method is characterized in that an aluminum compound and a lithium compound are added to an aqueous solution containing a phosphate compound and having a pH of 7 or above so that a lithium phosphate compound and Al₂O₃ are prepared for production of a positive electrode material.

By the production method of the present invention, the positive electrode material of the present invention can be produced easily.

In the production method of the present invention, the pH of the aqueous solution can be adjusted with the addition of an ammonia-containing compound.

In the present invention, the lithium phosphate compound and Al₂O₃ are preferably mixed with the positive active material in the aqueous solution. For example, the positive active material is first added and dispersed in the aqueous solution at a pH of 7 or above. The aluminum compound and the lithium compound are subsequently added to the aqueous dispersion so that the lithium phosphate compound and Al₂O₃ are precipitated. As a result, a mixture of the lithium phosphate compound, Al₂O₃ and positive electrode material is obtained. Alternatively, the aluminum compound and the lithium compound may be added to the aqueous solution at a pH of 7 or above to which the positive active material is subsequently added. According to these methods, the lithium phosphate compound and Al₂O₃ can be disposed near a surface of the positive active material.

In the production method of the present invention, the aluminum compound and the lithium compound may be added to the aqueous solution at a pH of 7 or above to prepare the lithium phosphate compound and Al₂O₃. These are dried and formed into a powder to which the positive active material is subsequently added.

In the production method of the present invention, the aluminum compound may be added to the aqueous solution at a pH of 7 or above to synthesize AlPO₄. The lithium compound is then added to substitute AlPO₄ with Li, so that the lithium phosphate compound and Al₂O₃ can be prepared.

The positive electrode material containing Li₃PO₄ and Al₂O₃ disposed near the surface of positive active material can be produced, for example, according to the following method. (NH₄)₂HPO₄ is dissolved in water. The resulting aqueous solution is adjusted with the addition of NH₃(aq) to a pH of 10 or above. The positive active material is added to the aqueous solution. Subsequently, an aqueous Al(NO₃)₃ solution is gradually added dropwise. The resulting solution is then stirred and centrifuged. After removal of a supernatant liquid, an LiOH solution is added. The resulting solution is again stirred and centrifuged. After removal of a supernatant liquid, the resultant is fired in the air at a temperature of not exceeding 800° C., e.g., at 400° C. for 5 hours. During this treatment, the reactions given by the following formulas are believed to take place.

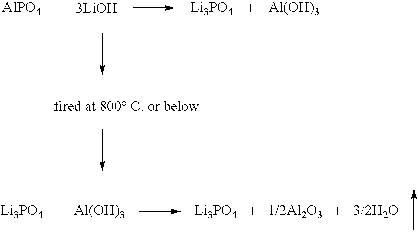

The addition of ammonia in the pH adjustment is to suppress deterioration of the positive active material due to the attack of an aqueous medium or acid during the above treatment and to allow ammonia to help disperse particles in the aqueous solution for production of finer particles. In the above method, AlPO₄ is produced in the aqueous alkaline solution. While AlPO₄ is dispersed in the aqueous alkaline solution, Al is substituted with LiOH. This prevents an abrupt pH change when LiₓPO_{y} (1≦x≦4, 1≦y≦4)−Al(OH)₃ is produced, so that smaller particle diameter LiₓPO_{y} (1≦x≦4, 1≦y≦4)−Al(OH)₃ can be produced. LiₓPO_{y} (1≦x≦4, 1≦y≦4)−Al(OH)₃ can be mixed with the positive active material in the better dispersed condition when the positive active material is added to the aqueous solution in which LiₓPO_{y} (1≦x≦4, 1≦y≦4)−Al(OH)₃ is produced and remains dispersed than when LiₓPO_{y} (1≦x≦4, 1≦y≦4)−Al(OH)₃ is added, in the form of particles, directly to the positive active material.

The positive electrode of the present invention can be fabricated, for example, by mixing the positive electrode material of the present invention, a binder and an optional component such as an electrical conductor to prepare a slurry and applying the slurry onto a current collector comprised of a metal foil such as an aluminum foil.

Examples of useful binders are polytetrafluoroethylene, polyvinylidene fluoride, polyethylene oxide, polyvinyl acetate, polymethacrylate, polyacrylate, polyacrylonitrile, polyvinyl alcohol, styrene-butadiene rubber, carboxymethyl-cellulose and the like.

If the amount of the binder in the positive electrode increases, the active material content of the positive electrode decreases. This may result in the failure to obtain a high energy density. Accordingly, the binder content of the positive electrode is generally kept in the range from 0% by weight to 30% by weight, preferably from 0% by weight to 20% by weight, more preferably from 0% by weight to 10% by weight.

In the case where the positive electrode comprises the positive active material superior in electrical conductivity, it functions sufficiently as an electrode without the addition of an electrical conductor. However, in the case where it uses low conducting active material, addition of a conductor to the positive electrode is desirable. Any conductor which has good electrical conductivity is applicable. In particular, highly conducting oxides, carbides, nitrides and carbon materials are useful. Examples of oxides include tin oxide and indium oxide. Examples of carbides include tungsten carbide and zirconium carbide. Examples of nitrides include titanium nitride and tantalum nitride. Low loading of the conductor may result in the failure to improve conductivity of the positive electrode sufficiently. On the other hand, if the loading thereof increases excessively, the active material content of the positive electrode decreases, possibly resulting in the failure to obtain a high energy density. Therefore, the conductor content of the positive electrode is generally kept in the range from 0% by weight to 30% by weight, preferably from 0% by weight to 20% by weight, more preferably from 0% by weight to 10% by weight.

The nonaqueous electrolyte secondary battery of the present invention is characterized as including a positive electrode using the aforesaid positive electrode material, a negative electrode and a nonaqueous electrolyte.

Because the nonaqueous electrolyte secondary battery of the present invention uses the aforesaid positive electrode material of the present invention, it attains good thermal stability and high discharge capacity and shows satisfactory charge-discharge cycle performance characteristics.

The negative electrode for use in the nonaqueous electrolyte secondary battery of the present invention may be composed of a material that is capable of storing and releasing lithium. Examples of such materials include metallic lithium, lithium alloys, carbon materials such as graphite, and silicon.

The electrolyte solvent for use in the nonaqueous electrolyte secondary battery of the present invention is not particularly specified but can be illustrated by cyclic carbonates, chain carbonates, esters, cyclic ethers, chain ethers, nitrites and amides.

Examples of cyclic carbonates include ethylene carbonate, propylene carbonate and butylene carbonate. All or part of hydrogen groups therein may be substituted with fluorine atoms. Examples are trifluoropropylene carbonate and fluoroethylene carbonate.

Examples of chain carbonates dimethyl carbonate, ethyl methyl carbonate, diethyl carbonate, methyl propyl carbonate, ethyl propyl carbonate and methyl isopropyl carbonate. All or part of hydrogen groups thereof may be substituted with fluorine atoms.

Examples of cyclic esters include methyl acetate, ethyl acetate, propyl acetate, methyl propionate, ethyl propionate and γ-butyrolactone.

Examples of cyclic ethers include 1,3-dioxolane, 4-methyl-1,3-dioxolane, tetrahydrofuran, 2-methyltetrahydro-furan, propylene oxide, 1,2-butylene oxide, 1,4-dioxane, 1,3,5-trioxane, furan, 2-methylfuran, 1,8-cineol and crown ethers.

Examples of chain ethers include 1,2-dimethoxyethane, diethyl ether, dipropyl ether, diisopropyl ether, dibutyl ether, dihexyl ether, ethylvinyl ether, butylvinyl ether, methyl-phenyl ether, ethylphenyl ether, butylphenyl ether, pentyl-phenyl ether, methoxytoluene, benzylethyl ether, diphenyl ether, dibenzyl ether, o-ximethoxybenzene, 1,2-diethoxy-ethane, 1,2-dibutoxyethane, diethylene glycol dimethyl ether, diethylene glycol diethyl ether, diethylene glycol dibutyl ether, 1,1-diethoxymethane, 1,1-diethoxyethane, triethylene glycol dimethyl ether and tetraethylene glycol dimethyl ether.

Examples of nitriles include acetonitriles. Examples of amides include dimethylformamides.

At least one selected from the above-listed compounds can be used as an electrolyte solvent.

Also, an electrolyte solute for use in the nonaqueous electrolyte secondary battery of the present invention can be illustrated by LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂ and mixtures thereof. Particularly, LiXF_{y} (in the formula, X is P, As, Sb, B, Bi, Al, Ga or In; y is 6 if X is P, As or Sb and 4 if X is B, Bi, Al, Ga or In), lithium perfluoroalkylsulfonic acid imide LiN(CₘF₂ₘ₊₁SO₂)(CₙF₂ₙ₊₁SO₂) (in the formula, m and n independently indicate an integer of 1-4), and lithium perfluoroalkylsulfonic acid methide LiC(CₚF₂ₚ₊₁SO₂)(C_{q}F_{2q+1}SO₂)(CᵣF₂ᵣ₊₁SO₂) (in the formula, p, q and r independently indicate an integer of 1-4) are preferably used.

The electrolyte can be illustrated by gelled polymer electrolytes comprised of an electrolyte solution impregnated into polymer electrolytes such as polyethylene oxide and polyacrylonitrile, and inorganic solid electrolytes such as LiI and LiN₃. The electrolyte for the nonaqueous electrolyte secondary battery of the present invention can be used without limitation, so long as a lithium compound as its solute that imparts ionic conductivity, as well as its solvent that dissolves and retains the lithium compound, remain undercomposed at voltages during charge, discharge and storage of the battery.

In accordance with the present invention, good thermal stability, high discharge capacity and satisfactory charge-discharge cycle performance characteristics can be obtained.

Also, even in the case where the end-of-charge voltage of the battery is increased, good thermal stability, high discharge capacity and satisfactory charge-discharge cycle performance characteristics can be obtained.

### BRIEF DESCRIPTION OF THE DRAWINGS

FIG. 1 shows an XRD measurement chart for the sample obtained in Reference Experiment 1;

FIG. 2 shows an XRD measurement chart for the sample obtained in Reference Experiment 2;

FIG. 3 is a schematic sectional view which shows the three-electrode beaker cell used in Examples;

FIG. 4 is a graph which shows, for comparative purposes, discharge capacities after 30 cycles as measured in Example 1, Comparative Examples 1, 3 and 5; and

FIG. 5 is a graph which shows, for comparative purposes, discharge capacities after 30 cycles as measured in Example 2, Comparative Examples 2, 4 and 6.

### DESCRIPTION OF THE PREFERRED EXAMPLES

The present invention is below described in more detail by way of Examples. It will be recognized that the following examples merely illustrate the present invention and are not intended to be limiting thereof. Suitable changes can be effected without departing from the scope of the present invention.

### REFERENCE EXPERIMENTS

In the following Reference Experiments 1 and 2, the compound, which was produced under the presence of the positive active material in Example 1 and Comparative Example 1, was produced under the absence of the positive active material and determined by XRD measurement.

### (Reference Experiment 1)

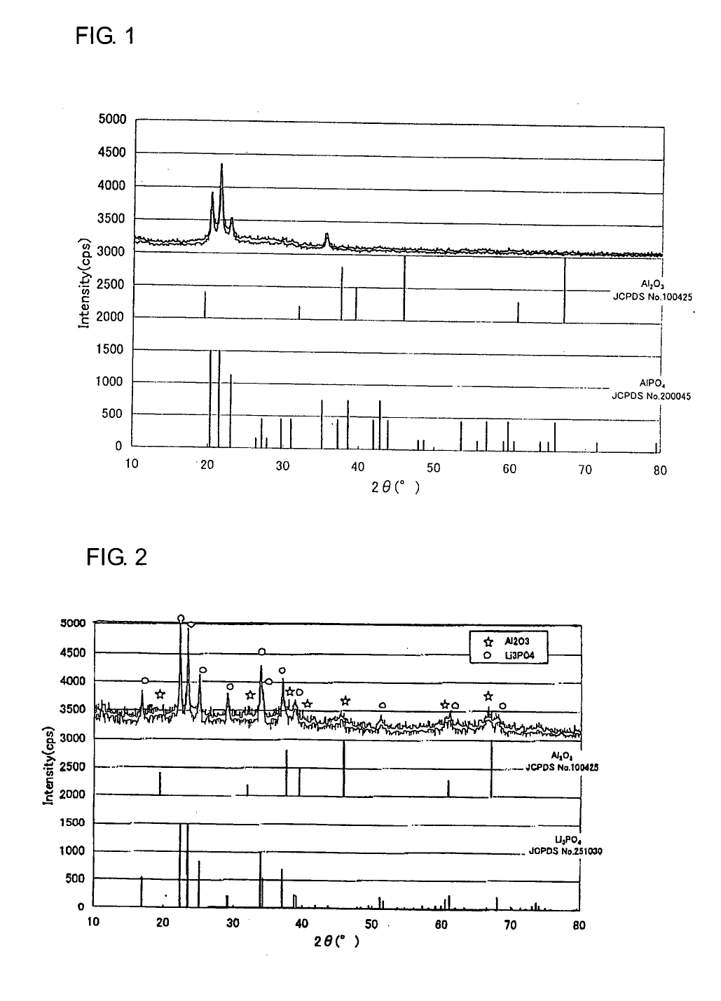

1.32 g (0.01 mol) of (NH₄)₂HPO₄ was dissolved in 20 ml water which was subsequently adjusted to a pH of 10 or above with the addition of NH₃ (aq). Thereafter, a solution containing 3.75 g (0.01 mol) of Al(NO₃)₃ in 20 ml water was gradually added dropwise. The resulting solution was stirred for 10 minutes and then centrifuged at 2,000 rpm. After removal of a supernatant liquid, the resultant was fired in the air at 400° C. for 5 hours to obtain a sample for XRD measurement. FIG. 1 shows an XRD measurement chart of the sample. As shown in FIG. 1, the intensity peaks of the sample coincide with those of AlPO₄. This confirmed production of AlPO₄.

### (Reference Experiment 2)

1.32 g (0.01 mol) of (NH₄)₂HPO₄ was dissolved in 20 ml water which was subsequently adjusted to a pH of 10 or above with the addition of NH₃ (aq). Thereafter, a solution containing 3.75 g (0.01 mol) of Al(NO₃)₃ in 20 ml water was gradually added dropwise. The resulting solution was stirred for 10 minutes and then centrifuged at 2,000 rpm. Subsequent to removal of a supernatant liquid, the resultant was added to an aqueous solution of 0.69 g (0.03 mol) of LiOH in 100 ml water. The aqueous solution was then stirred and again centrifuged at 2,000 rpm. After removal of a supernatant liquid, the resultant was fired in the air at 400° C. for 5 hours to obtain a sample for XRD measurement. FIG. 2 shows an XRD measurement chart of the sample. As shown in FIG. 2, the intensity peaks of Li₃PO₄ and Al₂O₃ appeared in the chart. This confirmed production of Li₃PO₄ and Al₂O₃.

From the results of the above Reference Experiments 1 and 2, the reaction formulations in Reference Experiment 2 have been found to be as follows.

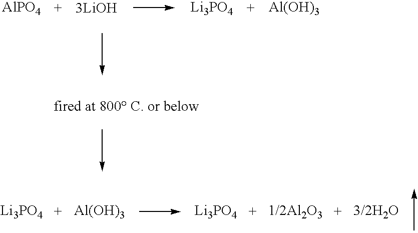

### EXAMPLE 1

Li₂CO₃ and CO₃O₄ were mixed in an Ishikawa automated mortar such that an Li:Co molar ratio was brought to 1:1. The mixture was heat treated in the air atmosphere at 850° C. for 24 hours and then pulverized to obtain LiCoO₂ with a mean particle diameter of about 14 μm.

1.32 g (0.01 mol) of (NH₄)₂HPO₄ was dissolved in 20 ml water which was subsequently adjusted to a pH of 10 or above with the addition of NH₃ (aq). 25 g of the above-prepared LiCoO₂ was added to the solution. Thereafter, a solution containing 3.75 g (0.01 mol) of Al(NO₃)₃ in 20 ml water was gradually added dropwise. The resulting solution was stirred for 10 minutes and then centrifuged at 2,000 rpm. After removal of a supernatant liquid, the resultant was added to a solution of 0.69 g (0.03 mol) of LiOH in 100 ml water. This solution was then stirred and again centrifuged at 2,000 rpm. After removal of a supernatant liquid, the resultant was fired in the air at 400° C. for 5 hours to obtain a positive electrode material of Example 1.

(Fabrication of Positive Electrode)

Polyvinylidene fluoride as a binder was dissolved in N-methyl-2-pyrrolidone as a dispersion medium. The above-prepared positive electrode material and a carbon material as an electrical conductor were subsequently added such that the ratio in weight of the positive electrode material to the conductor to the binder was brought to 90:5:5. The resultant was then kneaded to prepare a cathode slurry. The cathode slurry was coated on an aluminum foil as a current collector, dried and then rolled by a pressure roll. Subsequent attachment of a current collector tab completed fabrication of a positive electrode.

(Preparation of Electrolyte Solution)

1 mole/liter of LiPF₆ was dissolved in a mixture containing ethylene carbonate and diethylene carbonate at a 3:7 ratio by volume to prepare an electrolyte solution.

(Construction of Three-Electrode Beaker Cell)

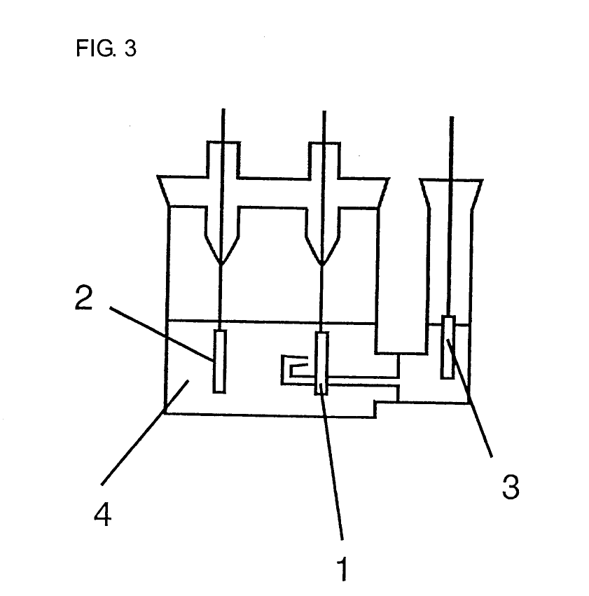

The three-electrode beaker cell shown in FIG. 3 was constructed in a glove box maintained under argon atmosphere. As shown in FIG. 3, the beaker contains an electrolyte solution 4 in which a work electrode 1, a counter electrode 2 and a reference electrode 3 are immersed. The above-fabricated positive electrode is used for the work electrode, while metallic lithium is used for the counter electrode and reference electrode.

The three-electrode beaker cell constructed under the above-described conditions was evaluated according to the following methods.

[Evaluation Method of Electrochemical Characteristics when End-of-Charge Potential is Set at 4.3 V (vs. Li/Li⁺)]

(Evaluation of Initial Charge-Discharge Characteristics)

The above-constructed three-electrode beaker cell at room temperature was charged at a constant current of 0.75 mA/cm² (about 0.3 C) until the work electrode potential reached 4.3 V (vs. Li/Li⁺) and further discharged at a constant current of 0.25 mA/cm² (about 0.1 C) until the potential reached 4.3 V (vs. Li/Li⁺) to evaluate initial charge-discharge characteristics.

Additional charge and discharge were performed under the same conditions as above to confirm 2nd-cycle charge-discharge characteristics.

(Evaluation of Charge-Discharge Cycle Characteristics)

Following the evaluation of initial charge-discharge characteristics, charge-discharge cycle characteristics were evaluated at room temperature. On the 3rd through 19th cycles and 21st through 29th cycles, the three-electrode beaker cell was charged at a constant current of 2.5 mA/cm² (about 1.0 C) until the work electrode potential reached 4.3 V (vs. Li/Li⁺), further charged at a constant current of 0.25 mA/cm² (about 0.1 C) until the potential reached 4.3 V (vs. Li/Li⁺) and then discharged at a constant current of 2.5 mA/cm² (about 1.0 C) until the potential reached 2.75 V (vs. Li/Li⁺). On the 20th cycle and 30th cycle, charge and discharge were performed under the same conditions as used in the evaluation of the initial charge-discharge characteristics and the second cycle. The charge-discharge cycle characteristics were confirmed by comparing discharge capacities when the 2nd-cycle discharge capacity was taken as 100%.

(Evaluation of Thermal Stability)

The same three-electrode beaker cell as described above was constructed. This three-electrode beaker cell at room temperature was charged at a constant current of 0.75 mA/cm² (about 0.3 C) until a work electrode potential reached 4.3 V (vs. Li/Li⁺), further charged at a constant current of 0.25 mA/cm² (about 0.1 C) until the potential reached 4.3 V (vs. Li/Li⁺) and then discharged at a constant current of 0.75 mA/cm² (about 0.3 C) until the potential reached 2.75V (vs. Li/Li⁺) to evaluate initial charge-discharge characteristics. Additional charge and discharge were performed under the same conditions to confirm charge-discharge characteristics on the 2nd cycle. Thereafter, the three-electrode beaker cell was charged at room temperature at a constant current of 0.75 mA/cm² (about 0.3 C) until the work electrode potential reached 4.3 V (vs. Li/Li⁺) and further charged at a constant current of 0.25 mA/cm² (about 0.1 C) until the potential reached 4.3 V (vs. Li/Li⁺). Subsequently, the three-electrode beaker cell was disassembled. 3 mg of the cathode mix in a charged state and 2 mg of ethylene carbonate were installed in a large-scale pressure-resistant aluminum seal cell. After sealed, the measuring apparatus DSC-60, available from Shimadzu Science Co., Ltd., was utilized to increase a temperature at 5° C./min to 350° C. to observe a quantity of heat emitted from the material.

### EXAMPLE 2

The procedure of Example 1 was followed to obtain a positive electrode material, fabricate a positive electrode and then construct a three-electrode beaker cell. This beaker cell was evaluated according to the following method to confirm its electrochemical characteristics with an increased end-of-charge potential and its thermal stability.

[Evaluation Method of Electrochemical Characteristics when End-of-Charge Potential is Set at 4.5 V (vs. Li/Li⁺)]

(Evaluation of Initial Charge-Discharge Characteristics)

The above-fabricated three-electrode beaker cell at room temperature was charged at a constant current of 0.75 mA/cm² (about 0.3 C) until the work electrode potential reached 4.5 V (vs. Li/Li⁺), further charged at a constant current of 0.25 mA/cm² (about 0.1 C) until the potential reached 4.5V (vs. Li/Li⁺) and then discharged at a constant current of 0.75 mA/cm² (about 0.3 C) until the potential reached 2.75V (vs. Li/Li⁺) to evaluate initial charge-discharge characteristics.

Additional charge and discharge were performed under the same conditions to confirm charge-discharge characteristics on the 2nd cycle.

(Evaluation of Charge-Discharge Cycle Characteristics)

Following the evaluation of initial charge-discharge characteristics, charge-discharge cycle characteristics were evaluated at room temperature. For the 3rd through 19th cycles and 21st through 29th cycles, the three-electrode beaker cell was charged at a constant current of 2.5 mA/cm² (about 1.0 C) until the work electrode potential reached 4.5 V (vs. Li/Li⁺), further charged at a constant current of 0.25 mA/cm² (about 0.1 C) until the potential reached 4.5 V (vs. Li/Li⁺) and then discharged at a constant current of 2.5 mA/cm² (about 1.0 C) until the potential reached 2.75 V (vs. Li/Li⁺). On the 20th cycle and 30th cycle, charge and discharge were performed under the same conditions as used in the evaluation of the initial charge-discharge characteristics and the second cycle. The charge-discharge cycle characteristics were confirmed by comparing discharge capacities when the 2nd-cycle discharge capacity was taken as 100%.

### COMPARATIVE EXAMPLE 1

Li₂CO₃ and CO₃O₄ were mixed in an Ishikawa automated mortar such that an Li:Co molar ratio was brought to 1:1. The mixture was heat treated in the air atmosphere at 850° C. for 24 hours and then pulverized to obtain LiCoO₂ with a mean particle diameter of about 14 μm.

1.32 g (0.01 mol) of (NH₄)₂HPO₄ was dissolved in 20 ml water which was subsequently adjusted to a pH of 10 or above with the addition of NH₃ (aq). 25 g of the above-prepared LiCoO₂ was added to the solution. Thereafter, a solution containing 3.75 g (0.01 mol) of Al(NO₃)₃ in 20 ml water was gradually added dropwise. The resulting solution was stirred for 10 minutes and then centrifuged at 2,000 rpm. After removal of a supernatant liquid, the resultant was fired in the air at 400° C. for 5 hours to obtain a positive electrode material of Comparative Example 1. The procedures of Example 1 were followed to fabricate a positive electrode and a negative electrode, prepare an electrolyte solution, construct a cell and perform a test under the specified conditions.

### COMPARATIVE EXAMPLE 2

The procedures of Comparative Example 1 were followed to obtain a positive electrode material, fabricate a positive electrode and then construct a three-electrode beaker cell. This beaker cell was evaluated according to the same method as in Example 2 to confirm its electrochemical characteristics with the increased end-of-charge potential.

### COMPARATIVE EXAMPLE 3

Li₂CO₃ and CO₃O₄ were mixed in an Ishikawa automated mortar such that an Li:Co molar ratio was brought to 1:1. The mixture was heat treated in the air atmosphere at 850° C. for 24 hours and then pulverized to obtain LiCoO₂ with a mean particle diameter of about 14 μm.

The obtained LiCoO₂ was added to 20 ml water having a pH value of about 6 and stirred for 10 minutes and then centrifuged at 2,000 rpm. After removal of a supernatant liquid, the resultant was fired in the air at 400° C. for 5 hours to obtain a positive electrode material of Comparative Example 3. The procedures of Example 1 were followed to fabricate a positive electrode and a negative electrode, prepare an electrolyte solution, construct a cell and perform a test under the specified conditions.

### COMPARATIVE EXAMPLE 4

The procedure of Comparative Example 3 was followed to obtain a positive electrode material. Using this positive electrode material, a positive electrode was fabricated. Subsequently, a three-electrode beaker cell was constructed and evaluated according to the same method as in Example 2 to confirm its electrochemical characteristics with the increased end-of-charge potential.

### COMPARATIVE EXAMPLE 5

Li₂CO₃ and CO₃O₄ were mixed in an Ishikawa automated mortar such that an Li:Co molar ratio was brought to 1:1. The mixture was heat treated in the air atmosphere at 850° C. for 24 hours and then pulverized to obtain LiCoO₂ having a mean particle diameter of about 14 μm as a positive electrode material of Comparative Example 5. The procedures of Example 1 were then followed to fabricate a positive electrode and a negative electrode, prepare an electrolyte solution, construct a cell and perform a test under the same conditions as in Example 1.

### COMPARATIVE EXAMPLE 6

The procedure of Comparative Example 5 was followed to obtain a positive electrode material. Using this positive electrode material, a positive electrode was fabricated. Subsequently, a three-electrode beaker cell was constructed and evaluated according to the same method as in Example 2 to confirm its electrochemical characteristics with the increased end-of-charge potential.

### COMPARATIVE EXAMPLE 7

Li₂CO₃ and CO₃O₄ were mixed in an Ishikawa automated mortar such that an Li:Co molar ratio was brought to 1:1. The mixture was heat treated in the air atmosphere at 850° C. for 24 hours and then pulverized to obtain LiCoO₂ with a mean particle diameter of about 14 μm.

1.32 g (0.01 mol) of (NH₄)₂HPO₄ was dissolved in 20 ml water which was subsequently adjusted to a pH of 10 or above with the addition of NH₃ (aq). 25 g of the above-prepared LiCoO₂ was added to the solution. Thereafter, an aqueous solution containing 0.69 g (0.03 mol) of LiOH in 100 ml water was gradually added dropwise. The resulting solution was centrifuged at 2,000 rpm. After removal of a supernatant liquid, the resultant was fired in the air at 400° C. for 5 hours to obtain a positive electrode material of Comparative Example 7. The procedures of Example 1 were then followed to fabricate a positive electrode and a negative electrode, prepare an electrolyte solution, construct a cell and perform a test under the specified conditions.

### COMPARATIVE EXAMPLE 8

The procedure of Comparative Example 7 was followed to obtain a positive electrode material. Using this positive electrode material, a positive electrode was fabricated. Subsequently, a three-electrode beaker cell was constructed and evaluated according to the same method as in Example 2 to confirm its electrochemical characteristics and thermal stability with the increased end-of-charge potential.

The evaluation results of the cells of Examples 1 and 2 and Comparative Examples 1-8, in terms of initial charge-discharge performance characteristics, charge-discharge cycle performance characteristics and thermal stability, are shown in Tables 1-3.

TABLE 1
Initial Charge-Discharge Characteristics

| | End-of-Charge | Initial Discharge |
|---|---|---|
| | Potential | Capacity |
| | (vs. Li/Li⁺) | (mAh/g) |
| EX. 1 | 4.3 V | 152 |
| COMP. EX. 1 | | 146 |
| COMP. EX. 3 | | 136 |
| COMP. EX. 5 | | 155 |
| COMP. EX. 7 | | 152 |
| EX. 2 | 4.5 V | 183 |
| COMP. EX. 2 | | 176 |
| COMP. EX. 4 | | 164 |
| COMP. EX. 6 | | 188 |
| COMP. EX. 8 | | 183 |

TABLE 2
Charge-Discharge Cycle Performance Characteristics

| | | | Capacity | Average |
|---|---|---|---|---|
| | End-of- | Discharge | Retention | Working |
| | Charge | Capacity | After 30 | Potential |
| | Potential | After 30 Cycles | Cycles | After 30 Cycles |
| | (vs. Li/Li⁺) | (mAh/g) | (%) | (vs. Li/Li⁺) |
| EX. 1 | 4.3 V | 150 | 97.1 | 3.896 |
| COMP. EX. 1 | | 142 | 96.5 | 3.893 |
| COMP. EX. 3 | | 80 | 57.4 | 3.318 |
| COMP. EX. 5 | | 114 | 71.0 | 3.755 |
| COMP. EX. 7 | | 129 | 84.1 | 3.638 |
| EX. 2 | 4.5 V | 177 | 95.6 | 3.959 |
| COMP. EX. 2 | | 168 | 95.4 | 3.928 |
| COMP. EX. 4 | | 117 | 70.0 | 3.309 |
| COMP. EX. 6 | | 138 | 72.8 | 3.370 |
| COMP. EX. 8 | | 133 | 73.5 | 3.462 |

TABLE 3
Thermal Stability

| | End-of-Charge | Exotherm Peak | Exotherm Peak |
|---|---|---|---|
| | Potential | Temperature | Height |
| | (vs. Li/Li⁺) | (° C.) | (mW) |
| EX. 1 | 4.3 V | 209.7 | 4.1 |
| COMP. EX. 1 | | 207.6 | 4.6 |
| COMP. EX. 3 | | 190.7 | 5.7 |
| COMP. EX. 5 | | 204.2 | 5.9 |
| COMP. EX. 7 | | 199.0 | 5.2 |

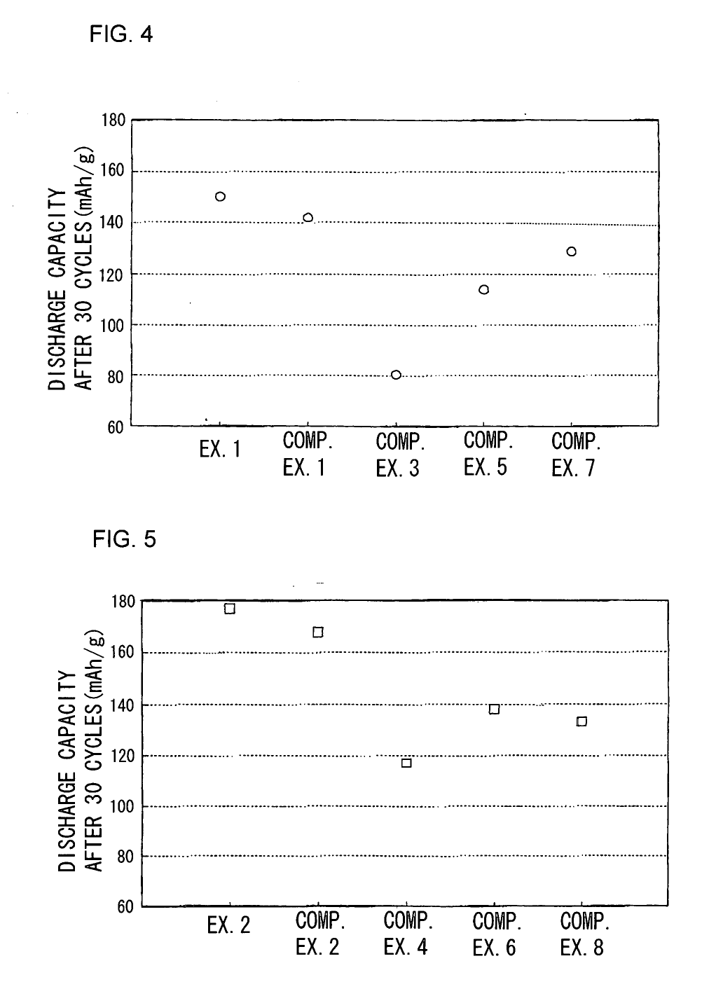

FIG. 4 is a graph which compares the discharge capacity after 30 cycles of the cell obtained in Example 1 to those of the cells obtained in Comparative Examples 1, 3 and 5. FIG. 5 is a graph which compares the discharge capacity after 30 cycles of the cell obtained in Example 2 to those of the cells obtained in Comparative Examples 2, 4 and 6.

As can be clearly seen from the results shown in Tables 1-3 and FIGS. 4 and 5, the cells of Examples 1 and 2 show higher initial discharge capacities and improved charge-discharge performance characteristics, as well as having higher discharge capacity densities and markedly improved ability to suppress deterioration of charge-discharge cycle performance characteristics even when the end-of-charge voltage is increased, compared to those of Comparative Examples 1 and 2.

The cells of Examples 1 and 2 also show improved initial discharge capacities and charge-discharge cycle performance characteristics, as well as having higher discharge capacity densities and increased ability to suppress deterioration of charge-discharge cycle performance characteristics even when the end-of-charge voltage is increased, compared to those of Comparative Examples 3 and 4. It is understood from the results of Comparative Examples 3 and 4 that the treatment is preferably carried out under the condition of pH of 7 or above.

The cells of Examples 1 and 2 show, in particular, improved charge-discharge cycle performance characteristics, compared to those of Comparative Examples 5 and 6. Even when the end-of-charge voltage is increased, they secure improved thermal stability while sustaining good charge-discharge cycle performance characteristics.

The cells of Examples 1 and 2 show, in particular, improved cycle performance characteristics, compared to those of Comparative Examples 7 and 8. Even when the end-of-charge voltage is increased, they secure improved thermal stability while sustaining good charge-discharge cycle performance characteristics.

The cells of Examples 1 and 2 use a positive electrode material in which the Li-ion conducting Li₃PO₄— Al₂O₃ is disposed near the positive active material. Although the cells of Comparative Examples 1 and 2 use a positive electrode material in which AlPO₄ is disposed near the surface of positive active material, they show lower initial discharge capacities and inferior charge-discharge cycle performance characteristics, compared to those of Examples 1 and 2.

Since the cells of Comparative Examples 7 and 8 use a positive electrode material in which the Li-ion conducting Li₃PO₄ is disposed near the positive active material, they show comparable initial discharge capacities. However, they show inferior charge-discharge cycle performance characteristics, relative to those of Examples 1 and 2.

This demonstrates that disposing Li₃PO₄— Al₂O₃ near the positive active material uniquely improves charge-discharge cycle performance characteristics while sustaining the initial discharge capacity.

As can also been clearly seen from comparison of the cells of Example 1 and Comparative Example 1, good thermal stability results are also obtained where Li₃PO₄—Al₂O₃ is disposed near the positive active material in accordance with the present invention.

High discharge capacities, comparable in level to the cells of Comparative Examples 5 and 6 which use conventional LicoO₂ alone as the positive active material, are obtained for those of Examples 1 and 2. This accordingly demonstrates that disposing the Li-ion conducting Li₃PO₄—Al₂O₃ near the positive active material improves charge-discharge characteristics and thermal stability without inhibiting a reaction between the electrolyte solution and the positive active material.

Although, in the present invention, the lithium phosphate compound and Al₂O₃ are mixed with the positive active material to use as the positive electrode material, they may be mixed with a negative active material to use as a negative electrode material. The use of such a negative electrode material is also believed to suppress decomposition of the electrolyte solution and prevent decomposition and dissolution of the active material in an effective fashion.

1. A positive electrode material for a nonaqueous electrolyte secondary battery, characterized in that it contains a positive active material capable of storing and releasing lithium, a lithium phosphate compound and Al₂O₃.

2. The positive electrode material for a nonaqueous electrolyte secondary battery as recited in claim 1, characterized in that said positive active material is a complex oxide comprised mainly of lithium and a transition metal.

3. The positive electrode material for a nonaqueous electrolyte secondary battery as recited in claim 1, characterized in that said positive active material is a lithium-containing layered complex oxide.

4. The positive electrode material for a nonaqueous electrolyte secondary battery as recited in claim 1, characterized in that said lithium phosphate compound is a compound represented by LiₓPO_{y} (1≦x≦4, 1≦y≦4).

5. The positive electrode material for a nonaqueous electrolyte secondary battery as recited in claim 4, characterized in that said lithium phosphate compound is Li₃PO₄.

6. The positive electrode material for a nonaqueous electrolyte secondary battery as recited in claim 1, characterized in that said lithium phosphate compound and Al₂O₃ are deposited on a surface of said positive active material.

7. The positive electrode material for a nonaqueous electrolyte secondary battery as recited in claim 1, characterized in that the total amount of said lithium phosphate compound and Al₂O₃ does not exceed 10% by weight, based on the weight of said positive active material.

8. A nonaqueous electrolyte secondary battery characterized as including a positive electrode comprised of the positive electrode material as recited in claim 1, a negative electrode and a nonaqueous electrolyte.

9. A method for producing a positive electrode material for a nonaqueous electrolyte secondary battery, for use in the production of the positive electrode material as recited in claim 1, characterized in that an aluminum compound and a lithium compound are added to an aqueous solution containing a phosphate compound and kept at a pH of 7 or above to thereby prepare said lithium phosphate compound and Al₂O₃.

10. The method for producing a positive electrode material for a nonaqueous electrolyte secondary battery as recited in claim 9, characterized in that the pH of said aqueous solution is adjusted using an ammonia-containing compound.

11. The method for producing a positive electrode material for a nonaqueous electrolyte secondary battery as recited in claim 9, characterized in that, subsequent to addition of said aluminum compound and lithium compound to the aqueous solution at a pH of 7 or above, said positive active material is added.

12. The method for producing a positive electrode material for a nonaqueous electrolyte secondary battery as recited in claim 9, characterized in that, subsequent to addition of said positive active material to the aqueous solution at a pH of 7 or above, said aluminum compound and lithium compound are added.

13. The method for producing a positive electrode material for a nonaqueous electrolyte secondary battery as recited in claim 9, characterized in that said aluminum compound is added to the aqueous solution at a pH of 7 or above to synthesize AlPO₄ and subsequently said lithium compound is added to substitute AlPO₄ with Li, whereby the lithium phosphate compound and Al₂O₃ are prepared.

14. The positive electrode material for a nonaqueous electrolyte secondary battery as recited in claim 2, characterized in that said lithium phosphate compound is a compound represented by LiₓPO_{y} (1≦x≦4, 1≦y≦4).

15. The positive electrode material for a nonaqueous electrolyte secondary battery as recited in claim 14, characterized in that said lithium phosphate compound is Li₃PO₄.

16. The positive electrode material for a nonaqueous electrolyte secondary battery as recited in claim 2, characterized in that said lithium phosphate compound and Al₂O₃ are deposited on a surface of said positive active material.

17. The positive electrode material for a nonaqueous electrolyte secondary battery as recited in claim 3, characterized in that said lithium phosphate compound is a compound represented by LiₓPO_{y} (1≦x≦4, 1≦y≦4).

18. The positive electrode material for a nonaqueous electrolyte secondary battery as recited in claim 17, characterized in that said lithium phosphate compound is Li₃PO₄.

19. The positive electrode material for a nonaqueous electrolyte secondary battery as recited in claim 3, characterized in that said lithium phosphate compound and Al₂O₃ are deposited on a surface of said positive active material.
